(19) United States
(12) Patent Application Publication
(10) Pub. No.: US 2025/0156703 A1
(43) Pub. Date: May 15, 2025

(54) STATE MACHINE DRIVEN AUTOMATED AGENT WITH NESTED AUDITING

(71) Applicant: Scaled Cognition, Inc., Amesbury, MA (US)

(72) Inventors: Dan Klein, Berkeley, CA (US); Mathew Gardner, Irvine, CA (US); Emmanouil Antonios Platanios, Fremont, CA (US); Mitchell Stern, Berkeley, CA (US); Adam Pauls, Berkeley, CA (US)

(73) Assignee: Scaled Cognition, Inc., Amesbury, MA (US)

(21) Appl. No.: 18/509,366

(22) Filed: Nov. 15, 2023

(51) Int. Cl. G06N 3/08; G06N 5/02

(52) U.S. Cl. CPC G06N 3/08; G06N 5/02

(57) ABSTRACT

A system providing a state-driven automated agent. The state machine can include multiple nested state machines to receive, process, and generate responses to a user inquiry received through a chat application. The state machine has a plurality of states, and navigates between states based on one or more machine learning (ML) models. In some instances, each state is associated with a machine learning model that can predict what state the state machine should transition to from its current state. The machine learning model(s) can be implemented using one or more large language models (LLM). The state-driven automated agent includes an auditing state that analyzes a predicted response to a user inquiry and identifies errors with the response. The errors may be identified and automatically self-corrected.

### BACKGROUND

Customer service assistant applications are becoming more common and adept at assisting customers with their needs. The customer service applications often interact with a customer through a chat application, in which the agent and customer may exchange text messages with other. In a typical exchange, a customer begins by entering an inquiry into a chat application. The customer service assistant application receives and processes the inquiry, generates a response, and transmits the response to the user.

In can be difficult for a customer service assistant application to correctly parse a user inquiry, generate the proper response, and provide the proper response to a user. Oftentimes, the customer service response to a user is either not helpful, times out, or provides a response that is not relevant to the inquiry. What is needed is an improved customer service assistant.

### SUMMARY

The present technology, roughly described, provides a state-driven automated agent. The state machine can include multiple nested state machines to receive, process, and generate responses to a user inquiry received through a chat application. The state machine has a plurality of states, and navigates between states based on one or more machine learning (ML) models. In some instances, each state is associated with a machine learning model that can predict what state the state machine should transition to from it's current state. The machine learning model(s) can be implemented using one or more large language models (LLM).

The state-driven automated agent includes an auditing state in at least one of the top and/or nested state machines. The auditing state analyzes a predicted response to a user inquiry and identifies errors with the response. The errors may be identified based on the output itself, instructions followed by the automated agent application to generate the response, or how the automated agent followed the instructions.

Upon finding an error, the audit state, or a nested state within the audit state, can gather state machine activity data related to the predicted response, and send the activity data to the appropriate state to generate a new response to the user inquiry. The state machine activity data can include functions executed by the automated agent application, instructions selected as relevant and followed by the automated agent application in predicting the response, and other data. The automated agent application can also prepare instructions to send to the appropriate state along with the state machine activity data. The instructions may indicate that the appropriate state should predict a new response while not repeating the errors detected by the audit regarding the previous response. With this process, the present system is able to detect errors in predicting a response to a user inquiry and automatically correct the errors before a response is communicated to a user.

In some instances, the present technology performs a method for providing a state-machine driven automated agent. The method begins with receiving a user inquiry data by a server from a remote device associated with a user. A response can then be predicted at a first state in a set of nested state machines, wherein the response is generated based on the user inquiry data. The present system can then automatically perform an audit of the predicted response at a second state in the set of nested state machines. The audited predicted response is then transmitted to the remote device if the automatically performed audit does not incur an error.

In some instances, the present technology includes a non-transitory computer readable storage medium having embodied thereon a program, the program being executable by a processor to provide a state-machine driven automated agent. The method begins with receiving a user inquiry data by a server from a remote device associated with a user. A response can then be predicted at a first state in a set of nested state machines, wherein the response is generated based on the user inquiry data. The present system can then automatically perform an audit of the predicted response at a second state in the set of nested state machines. The audited predicted response is then transmitted to the remote device if the automatically performed audit does not incur an error.

In some instances, the present technology includes a system having one or more servers, each including memory and a processor. One or more modules are stored in the memory and executed by one or more of the processors to receive user inquiry data by a server from a remote device associated with a user, predict a response at a first state in a set of nested state machines, the response is generated based on the user inquiry data, automatically perform an audit of the predicted response at a second state in the set of nested state machines, and automatically transmit the audited predicted response to the remote device if the automatically performed audit does not incur an error.

### BRIEF DESCRIPTION OF FIGURES

FIG. 1 is a block diagram of a system providing a state machine driven automated agent.

FIG. 2 is a block diagram of an automated agent application.

FIG. 3 is a block diagram of a state transition system.

FIG. 4 is a block diagram of a conversation manager.

FIG. 5 is a block diagram of data flow for a machine learning model.

FIG. 6 is a top level state machine for processing a user inquiry received by an automated agent.

FIG. 7 is a nested state machine for predicting a function state.

FIG. 8 is a nested state machine for auditing a predicted response.

FIG. 9 is a nested state machine for fixing an issue identified by an audit process.

FIG. 10 is a method for processing a user inquiry received by an automated agent.

FIG. 11 is a method for predicting a function state.

FIG. 12 is a method for auditing a predicted response to a user inquiry.

FIG. 13 is a method for fixing errors found in an audit of a predicted response.

FIG. 14 is a block diagram of a computing environment for implementing the present technology.

### DETAILED DESCRIPTION

The present technology, roughly described, provides a state-driven automated agent. The state machine can include multiple nested state machines to receive, process, and generate responses to a user inquiry received through a chat application. The state machine has a plurality of states, and navigates between states based on one or more machine learning (ML) models. In some instances, each state is associated with a machine learning model that can predict what state the state machine should transition to from its current state. The machine learning model(s) can be implemented using one or more large language models (LLM).

The state-driven automated agent includes an auditing state in at least one of the top and/or nested state machines. The auditing state analyzes a predicted response to a user inquiry and identifies errors with the response. The errors may be identified based on the output itself, instructions followed by the automated agent application to generate the response, or how the automated agent followed the instructions.

Upon finding an error, the audit state, or a nested state within the audit state, can gather state machine activity data related to the predicted response, and send the activity data to the appropriate state to generate a new response to the user inquiry. The state machine activity data can include functions executed by the automated agent application, instructions selected as relevant and followed by the automated agent application in predicting the response, and other data. The automated agent application can also prepare instructions to send to the appropriate state along with the state machine activity data. The instructions may indicate that the appropriate state should predict a new response while not repeating the errors detected by the audit regarding the previous response. With this process, the present system is able to detect errors in predicting a response to a user inquiry and automatically correct the errors before a response is communicated to a user.

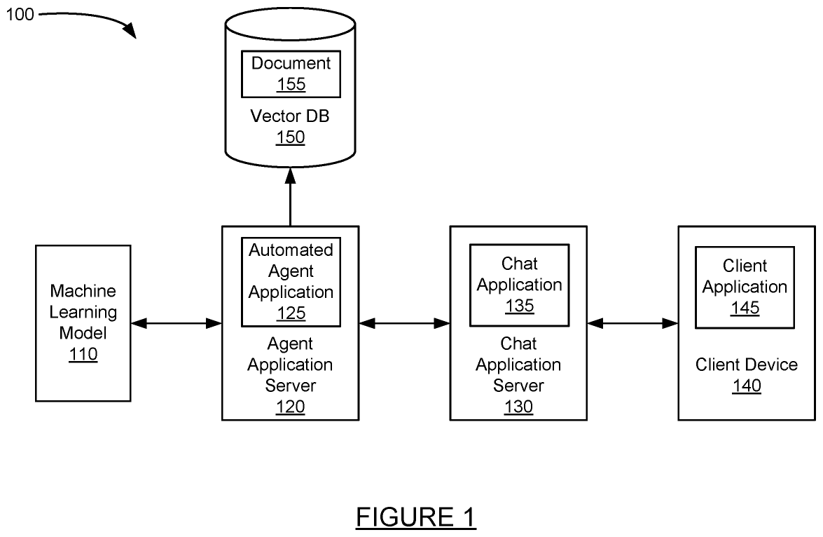

FIG. 1 is a block diagram of a system providing a state machine driven automated agent. System 100 of FIG. 1 includes machine learning model 110, agent application server 120, chat application server 130, client device 140, and vector database 150.

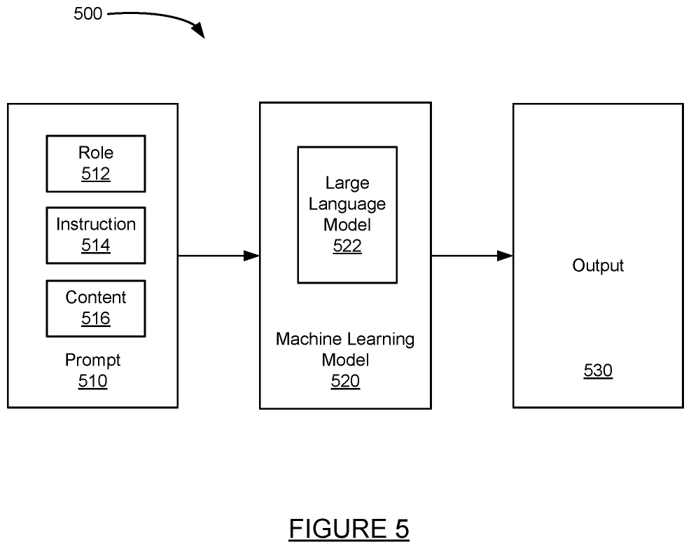

Machine learning model 110 may include one or more models or prediction engines that may receive an input, process the input, and predict a based on the input result. In some instances, machine learning model 110 may be implemented on agent application server 120, on the same physical or logical machine as automated agent application 125. In some instances, machine learning model 110 may be implemented by a large language model, on one or more servers external to agent application server 120. Implementing the machine learning model 110 as one or more large language models is discussed in more detail with respect to the method of FIG. 5.

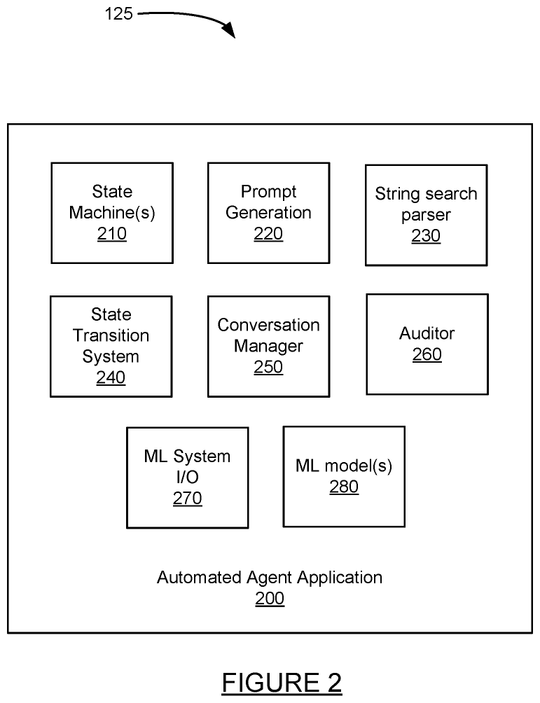

Agent application server 120 may include an automated agent application 125, and may communicate with machine learning model 110, chat application server 130, and vector database 150. Automated agent application 125 may be implemented on one or more servers 120, may be distributed over multiple servers and platforms, and may be implemented as one or more physical or logical servers. Automated agent application 125 may include several modules that implement the functionality described herein. More detail for automated agent application 125 is discussed with respect to FIG. 2.

Chat application server 130 may communicate with agent application server 120, client device 140, and may implement a conversation over a network, such as for example a “chat,” between an automated agent application provided by agent application server 120 and a customer entity. The customer entity may be a simulated customer, or an actual customer. When implemented as an actual customer, the chat application may communicate with a customer through client application 145 on client device 140, which may communicate with chat application 125 on chat application server 130. Client application 145 may be implemented as an app or a network browser on a computing device such as a smart phone, tablet computer, laptop computer, or other computer, or some other application.

Vector database 150 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge bases. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers. Vector database 150 may include data such as prompt templates, instructions, training data, and other data used by automated agent application 125 and machine learning model 110.

In some instances, instructions may be generated automatically from training materials associated with a service that provides automated agent application 125. Generating instructions automatically from training materials is discussed in more detail with respect to US patent application number NUMBER, titled “TITLE”, filed on DATE. (TO BE FILLED OUT AFTER PREVIOUS APPLICATION IS FILED)

Each of model 110, servers 120-130, client device 140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 110, 120, 130 and 140 may be implemented in one or more cloud-based service providers, such as for example AWS by Amazon Inc, AZURE by Microsoft, GCP by Google, Inc., Kubernetes, or some other cloud based service provider.

FIG. 2 is a block diagram of an automated agent application. Automated agent application 200 of FIG. 2 provides more detail for automated agent application 125 of the system of FIG. 1. Application 200 of FIG. 2 includes state machines 210, prompt generation 220, string search parser 230, state transition system 240, conversation manager 250, auditor 260, machine learning system I/O module 270, and machine learning models 280.

State machines 210 may define the behavior of an automated agent provided by the present system. The state machine implemented herein, in some instances, may include a top-level state machine and one or more nested state-machines, as well as state machines running in parallel to or asynchronously to the top level state machine or nested state machines. One or more of the state machines may include an auditing state embedded within the particular state machine.

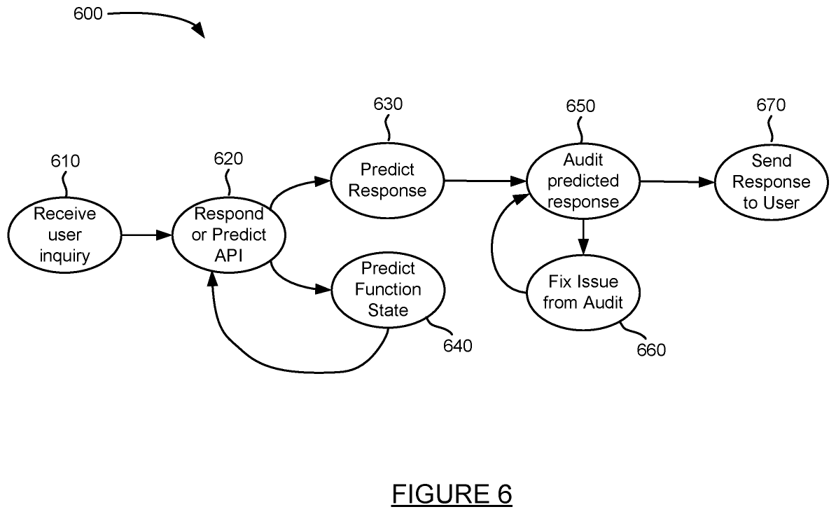

The state of each state machine may optionally be associated with a machine learning model. As such, to determine what the next state is from a particular current state within a state machine, the state may provide transition data to a machine learning model. The machine learning model will indicate the next state from the current state based on the transition data. The transition data can include one or more of the state transition history, the user inquiry, relevant instructions for the automated agent in handling the user inquiry, information regarding one or more programs selected and executed during the current state session, audit and/or error data, and other content. In some instances, each state machine provides the transition data as complete or partial information to be included into a prompt, wherein the prompt is to be provided to a large language model. The large language model indicates the appropriate state to transition to from the current state. Examples of state machines are discussed with respect to FIGS. 6-9.

Prompt generation 220 may operate to generate a prompt to be fed into a large language model. A prompt may include one or more of request, role data associated with the role that the automated agent is to have during a conversation, a user inquiry, instructions retrieved based on the user inquiry, audit data, and optionally other data. The request may indicate what the large language model is requested to do, for example find relevant instructions, determining a next state from the current state, determine a response for a user inquiry, select a function or program to be executed, perform an audit of a predicted response, or some other goal. A role is a level of permission and authority that the automated agent has in a customer service capacity, such as a bottom level agent, a supervisor, a manager, or some other role. The instructions may include the rules, guidelines, and other guides for controlling what an automated agent can and cannot do when assisting a customer through a conversation or chat. Other data that may be included in a prompt, in addition to a request, role, and instructions, may include a series of actions not to do (e.g., a series of actions determined to be incorrect by an auditor).

A string search parser 230 may parse a string search sequence into a program. In some instances, for a state designed to identify a program to execute, a machine learning model may return string search data. A string search parser may parse the returned string search to identify the program to be run.

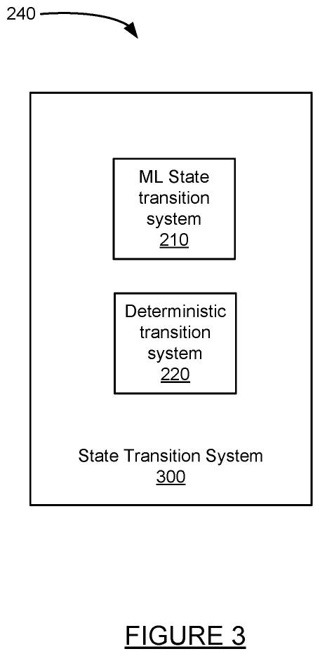

A state transition system may determine the transition from one state to another state. The state transition system may handle transitions within a state machine, transitions to a nested and/or embedded state machine, and other transitions. The transition system 240 may include machine learning state transition and deterministic transition. More detail for straight transition system 240 is discussed with respect to the block diagram of FIG. 3.

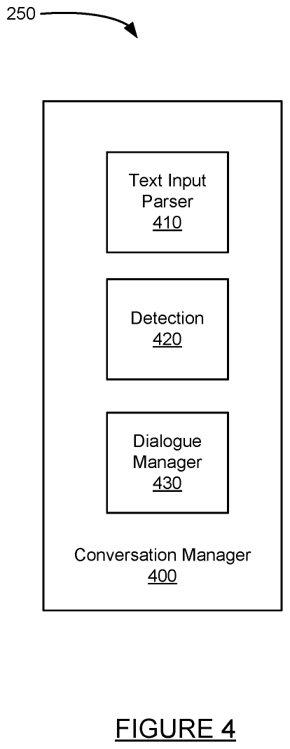

Conversation manager 250 may manage a conversation between automated agent application 125 and client application 145. In some instances, conversation manager 250 may be implemented at least in part by an automated agent application 125. In some instances, conversation manager 250 may be implemented at least in part in chat application 125. The conversation manager may have capabilities such as parsing text input, detecting meaning within parsed text, and managing dialogue to and from a participant in the conversation. More details for conversation manager 250 are discussed with respect to the conversation manager of FIG. 4.

Auditor 260 may audit a predicted response from an automated agent to a customer at client application 145. The auditor may confirm if instructions followed were relevant, if the instructions were followed properly, and confirm other aspects related to generating a response to a customer inquiry.

Machine learning system I/O 270 may communicate with one or more machine learning models 110 280. ML system I/O 270 may provide prompts or input to and receive or retrieve outputs from machine learning models 110 and 280.

Machine learning model(s) 280 may include one or more machine learning models that generate predictions for state machines 210, and receive prompts, instructions and requests to provide a response to particular inquiry, as well as perform other tasks.

Modules illustrated in automated agent application 200 are exemplary, and could be implemented in additional or fewer modules. Automated agent application 200 is intended to at least implement functionality described herein. The design of specific modules, objects, programs, and platforms to implement the functionality is not specific and limited by the modules illustrated in FIG. 2.

FIG. 3 is a block diagram of a state transition system. State transition system 300 of FIG. 3 provides more detail for state transition system 240 of the block diagram of FIG. 2. State transition system includes machine learning state transition system 210 and deterministic transition system 220. Machine learning state transitions system 210 may use one or more machine learning models to determine what state of transition to from the present state in a top-level state diagram or any nested, asynchronous, or other state machine. State transition system 210 may, for example, gather a prompt from prompt generation 220, feed the prompt to machine learning system I/O 270, and retrieve the machine learning model output from ML system by/02 70 as generated by the one or more machine learning models 280 or 110.

Deterministic transition system 220 may use a deterministic method or algorithm to identify a transition from one state to a next state. In some instances, other algorithms or methodologies can be used to transition from a current state to a next state, and the transition system is not limited to the machine learning straight transition system and deterministic transition system as illustrated in system 300 of FIG. 3.

FIG. 4 is a block diagram of a conversation manager. Conversation manager 400 provides more detail for conversation manager 250 of the block diagram of FIG. 2. Conversation manager 400 includes a text input parser for 10, detection module 420, and dialogue manager 430. In some instances, conversation manager 400 may be implemented within chat application 125, automated agent application 135, or distributed between applications 125 and 135.

Text input parser 410 may parse text input provided by client to chat application 135. Detection 420 may analyze the parsed text to determine intent and meaning of the parsed text. Dialogue manager 430 may manage input received from client application 145 an automated agent application 125 into the conversation between them.

FIG. 5 is a block diagram of data flow for a machine learning model. The method of FIG. 5 includes prompt 510, machine learning model 520, and output 530.

Prompt 510 of FIG. 5 can be provided as input to a machine learning model 520. A prompt can include information or data such as a role 512, instructions 514, and content 516. The role indicates the authority level at which the automated agent is to assume while working to assist a user. For example, a role can include an entry-level customer service representative, a manager, a director, or some other customer service job with a particular level of permissions and rules that apply to what they can do and can't do when assisting a customer.

Instructions 514 can indicate what the machine learning model (e.g., a large language model) is supposed to do with the other content provided in the prompt. For example, the machine learning model instructions may request, via instructions 514, an LLM to select the most relevant instructions from content 230 to train or guide a customer service representative having a specified role 210, determine if a predicted response was generated with each instruction followed correctly, determine what function to execute, determine whether or not to transition to a new state within a state machine, and so forth. The instructions can be retrieved or accessed from document 155 of vector database 150.

Content 516 may include data and/or information that can help a ML model or LLM generate an output. For an ML model, the content can include a stream of data that is put in a processable format (for example, normalized) for the ML model to read. For an LLM, the content can include a user inquiry, retrieved instructions, programs and functions executed by a state machine, the series of states navigated in a state machine, results of an audit, and other content. In some instances, where only a portion of the content or a prompt will fit into an LLM input, the content and/or other portions of the prompt can be provided to an LLM can be submitted in multiple prompts.

Machine learning model 520 of FIG. 5 provides more detail for machine learning model 110 of FIG. 1. The ML model 520 may receive one or more inputs and provide an output. In some instances, the ML model may predict an output in the form of whether to transition to a particular state within a state machine, whether a particular instruction is relevant, or some other prediction.

ML model 520 may be implemented by a large language model 522. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT03 by OpenAI, or other LLM. In some instances, machine learning model 115 may be implemented by one or more other models or neural networks.

Output 530 is provided by machine learning model 520 in response to processing prompt 510 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions during a conversation with a user, the machine learning model may return a confidence score, prediction, or other indication as to whether the instructions were followed correctly by the automated agent.

The present system includes a state-driven automated agent. The state-driven system includes a top level state machine and multiple nested state machines, wherein the nested state machines are within other states of higher state-machines within the system. In some instances, a plurality of the state machines include an auditing state to detect errors in, for example, a predicted response or a selected program. The set of nested state machines implements the automated agent and uses ML models, LLMs, or deterministic transition to determine when and where the next state in a state machine should be. FIGS. 6-9 describe an exemplary set of nested state machines that implement the present technology. The state machines in FIGS. 6-9 are exemplary, and the specific state machines, states, state order, and nesting are not intended to limit the scope of the present technology.

FIG. 6 is a top level state machine for processing a user inquiry received by an automated agent. At initial state 610, a user inquiry is received. The user inquiry can be received through chat application 135 by automated agent application 125. The state machine then transitions to step 620, where the system determines if it should respond to the inquiry or predict an API.

In some instances, a state transition is determined using a machine learning model. The machine learning model may receive input, such as programs executed during the state machine process, previous state outputs, and other data. When the machine learning model is implemented as a large language model, an output of a previous state may be provided as a prompt to the large language model to determine whether the state machine should transition to a next state. For example, to determine whether the system should respond to a user inquiry or predict an API at step 620, the prompt may include the user inquiry, a list of relevant instructions, and a request to decide whether the system should respond to the inquiry or predict an API function state.

In some instances, a deterministic system may be used to determine state transition. For example, if a current state only has one other state it can move forward to, the deterministic system determines when the appropriate time is to move from the current state to the only available next state.

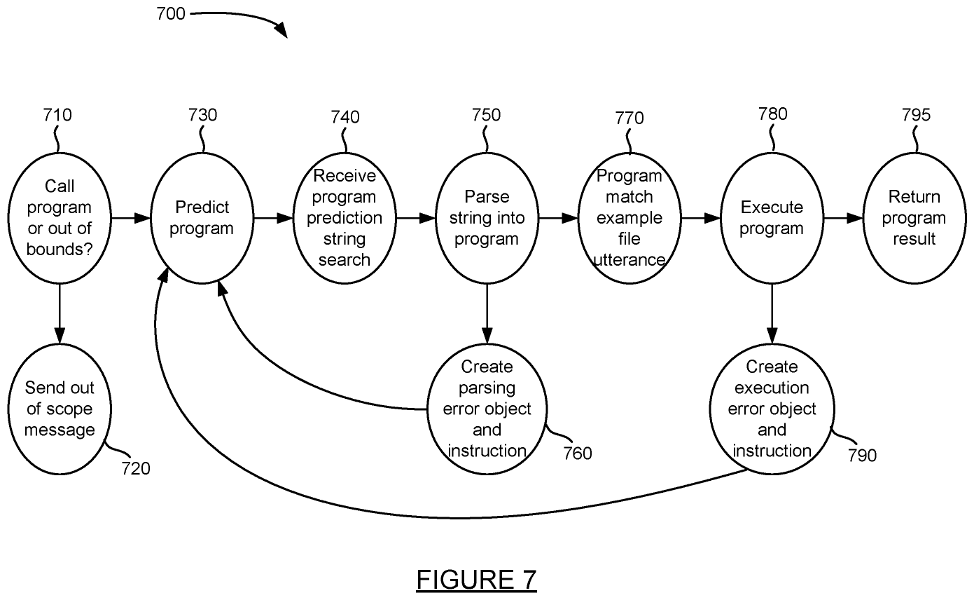

At step 620, if a state transition system determines the next appropriate state is the predict function or API state 640, the state transitions to state 640 to predict a function. At this state, a function or program is predicted that will be executed by the present system. The predict function state has an embedded state machine 700 which is discussed with respect to the state machine of FIG. 7. Once the function state is predicted, the state machine transitions back to state 620 where another determination is made as to whether the system should respond to the user inquiry or predict another API.

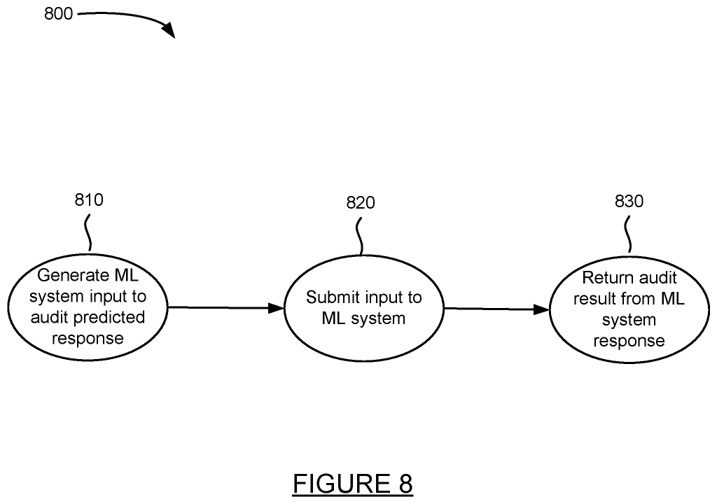

If the state transition system determines the next state should be to predict a response, the state machine transitions to state 630, where a response is predicted. Predicting a response means generating a response to the user inquiry based on executed programs, instructions, and other content. After predicting a response, the state machine of FIG. 6 transitions to state 650, where the predicted response is audited. Auditing the response may include determining if each and every instruction was followed correctly. State 650 for auditing a predicted response includes a nested state machine which is discussed with more detail with respect to the state machine of FIG. 8.

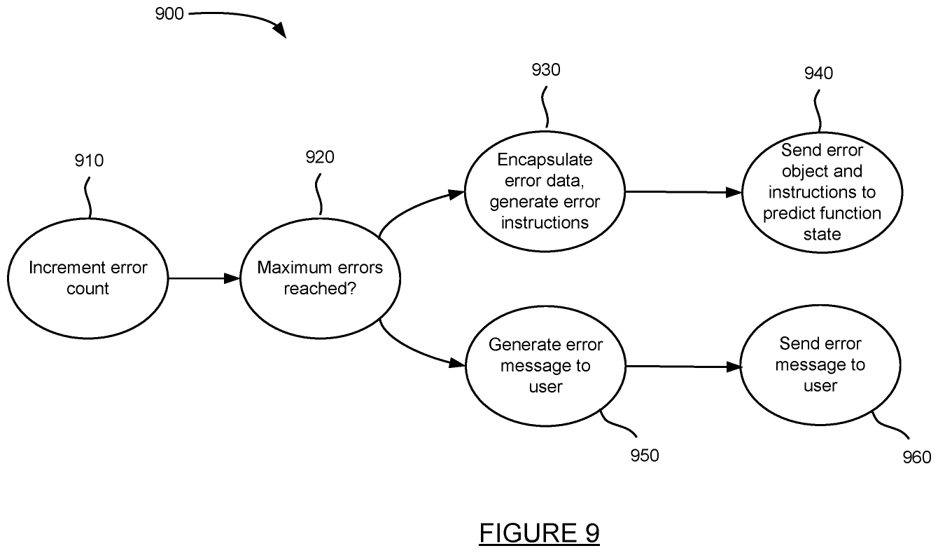

If the result of the audit of the predicted response is that the predicted response is acceptable, the state machine transitions to state 670 where the response is transmitted to a user. If the results of the audit indicates an error, the state machine transitions to step 660 where the system will attempt to fix the error and/or issue from the audit. Step 660 has an embedded state machine which is described in more detail with regards to FIG. 9.

FIG. 7 is a nested state machine for predicting a function state. The state machine begins at state 710, where a decision is made as to whether the system should call a program or determine that the inquiry is out of bounds. If an LMM is used to determine the next state, to determine whether to call a program or that the user inquiry is out of bounds, the user inquiry, relevant instructions, programs executed so far, and a request to select the next state are submitted to a large language model along with a request to determine which state should be next. The LLM will output which of the two states should be the next state. For a machine learning model, the inquiry, relevant instructions, and programs executed so far are submitted as model input, the machine learning model can provide a prediction for each possible next state. The potential next state with the highest probability is selected as the next state in the state machine. This model for using an LLM and ML model can be used for determining transition with other states in the state machines discussed herein.

If the next state is state 720, then the system has determined that it cannot reply to the user inquiry. As such, a message indicating that the automated agent can't answer that inquiry right now is generated and transmitted to the user through the chat application 135.

If the next state is state 730, a program is predicted. The prediction of the program may involve providing the user inquiry, relevant instructions, and the programs called so far as a prompt to a large language model. The large language model receives the prompt, and determines a prediction in the form of a string. The program prediction string is received at state 740. The received program prediction string can be parsed into an actual program at state 750. If the parsing is successful, the state machine transitions to state 770. If the parsing is not successful, a parsing error object is created along with instructions to predict a different program at state 760, and then the state machine continues to state 730 were a new program is predicted.

At state 770, the parsed program is compared to a program listed in a file of paired or matched programs and user utterances. In some instances, the present system may contain a list of programs matched to utterances or inquiries from a customer. For example, if a customer asks what flights are available to Dallas tomorrow, the matching program may be an airline scheduling program. The matching program can provide flight information to different cities on particular days. In some instances, if the customer utterance is found in the list of matching files, and the program selected is not the corresponding program matched to the utterance, an error may be generated, along with an instruction to predict a new program. In some instances, the matching program will be selected instead of the predicted program. In some instances, the predicted program can be added to the particular utterance and the matching program and utterance file can be updated accordingly.

The state machine state transitions to step 780, where the predicted program can be executed. If the program executes correctly, the result of the executed program is returned to the top level state machine of FIG. 6. If there is an error in executing the program, and execution error object and instructions are created at state 790, and the state transitions to step 730 with input of the created object and instructions.

FIG. 8 is a state machine for auditing a predicted response. The state machine of FIG. 8 is a nested state machine within state 650 of the state machine of FIG. 6. In the first state 810, machine learning input is generated to audit the predicted response. Once the input is generated, the state machine transitions to state 820 where the input is submitted to the machine learning system. Once the input is input into an ML model, the state machine transitions to step 830 where the output from the ML model is returned to state 650 of the state machine of FIG. 6.

FIG. 9 is a state machine for fixing an error or issue identified by an audit process. The state machine of FIG. 9 is a nested state machine within state 660 of the state machine of FIG. 6. At initial state 910, an error count is incremented. After incrementing the error account, the state machine transitions to step 920 where a determination is made as to whether the maximum number of errors has been reached. In some instances, if the present system has reached a certain number of errors trying to process a customer inquiry, the system will stop trying to generate a response to the inquiry and notify the customer that the system is not able to process the inquiry. As such, the system transitions to step 950 where an error message for a user is generated, and the state machine transitions to state 960 where the error message is sent to the user through the chat application.

If the maximum number of errors is not reached at state 920, the state machine transitions to step 930 where the error data from the audit is encapsulated along with instructions. Instructions may include information about the error that occurred and how to process the inquiry differently during the next iteration of the state machine such that the same error does not occur. After incapsulating error data and generating instructions, the state machine transitions to step 940 where the error object and instructions are provided as input to predict function state 640 of the state machine of FIG. 6.

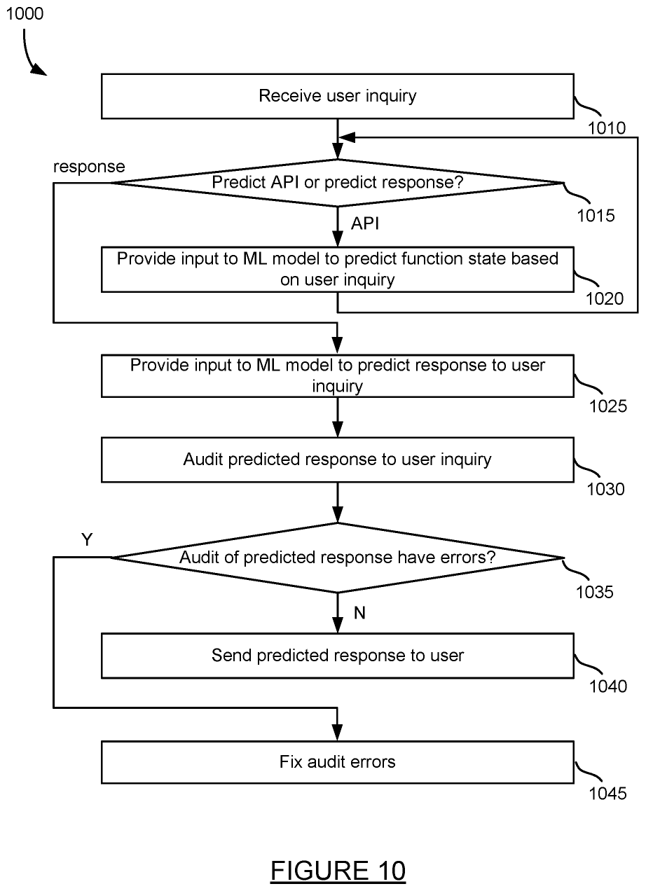

The methods of FIGS. 10-13 provide more detail for the operation of the state machines in FIGS. 6-9.

FIG. 10 is a method for processing a user inquiry received by an automated agent. The method of FIG. 10 is related to the state machine of FIG. 6. First, a user inquiry is received at step 1010. The user inquiry may be received by an automated agent application through chat application 135, and may originate from client application 145. The user inquiry may be a request from a user to the automated agent to perform a task, provide information, or do some other action.

A determination is made at step 1015 as to whether the system should predict an API or predict a response. The decision to predict an API or predict a response is made, in some instances, by a machine learning model. The machine learning model may predict the likelihood that each of the two states is the next state, such that the ML model may predict both the probability that the next state should be to predict API state and a separate prediction as was to whether the next state should be to predict a response. The state with the highest prediction would be the state that the state machine transitions to.

In some instances, a large language model can be used with a prompt, instructions, and a request that requires the large language model to decide whether the predict API state or predict response state should be the next state in the state machine. If the predict API state should be the next state, an input is provided to a machine learning model to predict a function state based on a user inquiry at step 1020. After predicting a function state, the method of FIG. 10 receives the function output and provides the output to step 1015 as input. The system proceeds to again predict whether the next state should be predict API or predict response.

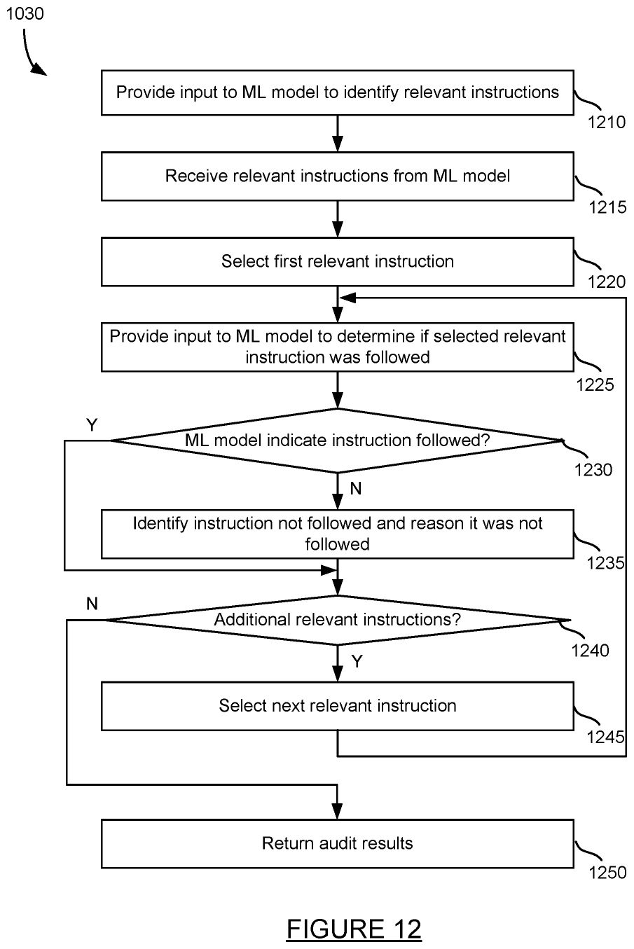

If predict response is the next state, input is provided to a machine learning model to predict a response to the user inquiry at step 1025. After predicting a response, the predicted response is audited at step 1030. The audit may include checking the response, instruction by instruction, to determine if there is an error in following each instruction. Auditing a predicted response to a user inquiry is discussed in more detail below with respect to the method of FIG. 12.

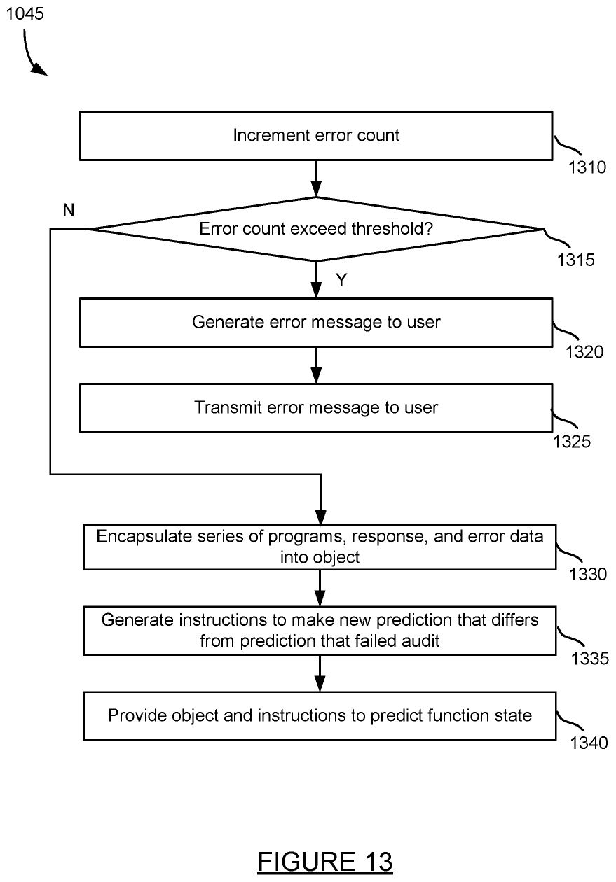

A determination is then made at step 1035 as to whether the audit of the predicted response resulted in any errors. If the audit triggered no error from the predicted response, the audit process is complete and the predicted response is transmitted to a user at step 1040. Transmitting the response to a user includes sending the response to chat application 135, which then relays the response to a user through client application 145. If the predicted response audit does result in one or more errors, the audit errors may be fixed at step 1045. In this manner, errors found in the predicted response to the user inquiry are automatically detected and corrected. This enables the state-driven system to be a self-correcting system. Fixing errors in an audit is discussed in more detail below with respect to the method of FIG. 13.

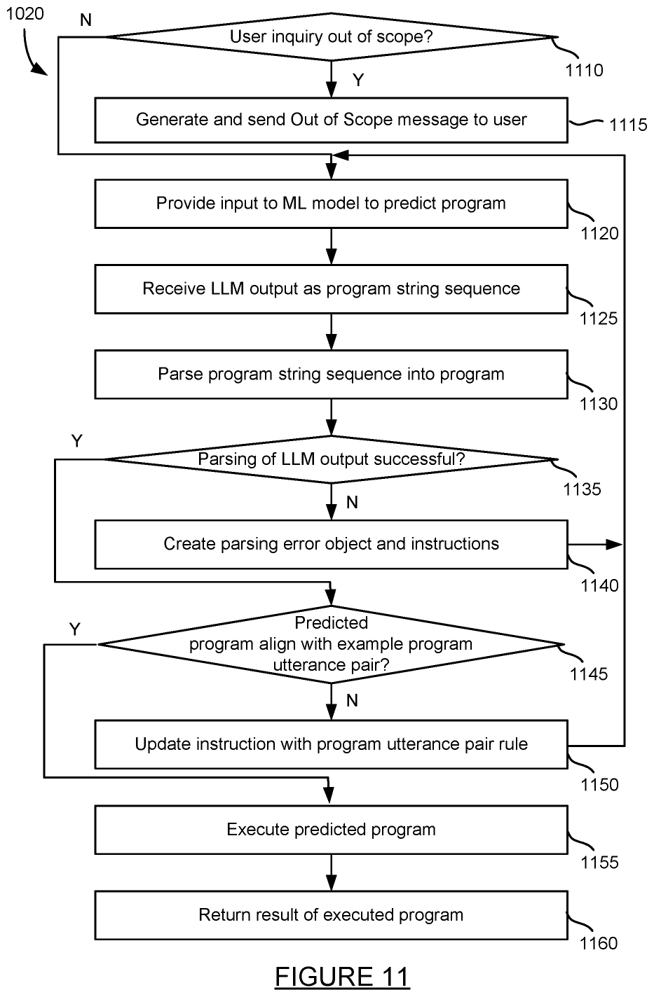

FIG. 11 is a method for predicting a function state. The method of FIG. 11 provides more detail for step 1020 of the method of FIG. 10. First, a determination is made as to whether the user inquiry is out of scope at step 1110. The user inquiry may be out of scope if it asks a question that is outside the expertise area of the present system. For example, if the present system provides an automated agent for a health care service, and the user inquiry is about the natural history of dinosaurs, the user inquiry is so different from the knowledge base that the system cannot answer the user question. If the user inquiry is out the scope, then the system has determined it cannot generate a response to the user inquiry, and an out of scope message is generated and transmitted to user at step 1115.

If the user inquiry is not out of scope of the present system knowledge base, an input is provided to a machine learning model to predict a program for handling the inquiry at step 1120. An ML model (in some instances, an LLM) output is received as a program string sequence at step 1125. The program string sequence is parsed into a program at step 1130. A determination is then made at step 1135 to determine if the parsing of the LM output was successful. In some instances, the parsing is successful if the parsing of the string results in a program that can be executed. If the parsing was not successful, a parsing error object and instructions are created at step 1140. The parsing error object includes instructions followed to generate the program, the output of the machine learning model, and the particular error with the parsing. The instructions indicate that a new program should be predicted without following the same steps that resulted in the program that caused the parsing error. The parsing error object and instructions are provided as input to a machine learning model used to predict the next program at step 1120.

If the parsing was successful, a determination is made as to whether the predicted program aligns with an example program utterance pair at step 1145. In some instances, the present system can store a list of user inquiries or utterances and programs known to be related to the user inquiry/utterance. If the predicted program does not align with an example program utterance and program pairing, instructions are updated with the new program utterance and the method of FIG. 11 may return to step 1120. In some instances, the instructions may be updated with the program utterance pairing rule at step 1150, wherein the pair includes the newly predicted program, and the method may continue to step 1155.

If the predicted program does match the example program utterance pairing, such that the predicted program matches a program and utterance pair, the predicted program is executed at step 1155. The result of the executed program is then returned to step 1020, and the method of FIG. 10 returns to step 1015.

FIG. 12 is a method for auditing a predicted response to a user inquiry. The method of FIG. 12 provides more detail for step 1030 of the method of FIG. 10. Input is provided to a machine learning model to identify relevant instructions at step 1210. Relevant instructions I received from the machine learning model at step 1215. The first relevant instruction is then selected at step 1220. Input is provided to the machine learning model to determine if the selected relevant instruction was followed at step 1225. A determination is then made at step 1230 as to whether the machine learning model indicated in the selected structure and was followed. If the machine learning model indicates instruction is not followed, instruction not followed is identified and the reason it is not followed at step 1235. The method then continues to step 1240.

If the instruction was followed at step 1230, a determination is made as whether there are additional relevant instructions to analyze at step 1240. If additional relevant instructions exist, the next relevant instruction is selected at step 1245, and the method returns to step 1225 to provide input to a machine learning model to determine if the newly selected relevant instruction was followed. If all relevant instructions have been analyzed, and there are no additional relevant instructions at step 1240, the audit results are returned to step 1030 and the method of FIG. 10. The other results may include each instruction and an indication as to whether or not instruction was correctly followed.

FIG. 13 is a method for fixing errors found in an audit of a predicted response. The method of FIG. 13 provides more detail for step 1045 of the method of FIG. 10. First, an error count is incremented at step 1310. In some instances, a mechanism in the present system ensures that the state-driven automated agent does not spend too much time trying to generate a proper response to a user inquiry. In some instances, the present system allows itself a threshold number of tries to determine a response to a user inquiry. The threshold amount may be five, ten, twenty, thirty, or some other number of attempts to generate a response with no errors. In some instances, the threshold is a period of time, rather than a count, such as for example 5 seconds, 10 seconds, 15 seconds, 20 seconds, or some other period of time.

A determination is made as to whether the incremented count has exceeded a threshold at step 1315. In some instances, if the present system generates a number of predicted responses that fail an audit a number of times (or takes a period of time) equal to a threshold, the system will stop attempting to generate a response to the inquiry and will send a message to the user indicating that it cannot answer that inquiry. The error message is generated at step 1320, and the error messages is transmitted to the user chat application 135 at step 1325.

If the account has not been exceeded, the series of programs generated so far, the response, and error data are encapsulated into an object at step 1330. Instructions may be generated that require a new response prediction that differs from the prediction that resulted in a failed audit at step 1355. After encapsulation and generating instructions, the object and instructions are provided as input to the predict function state 640 of the method of FIG. 6.

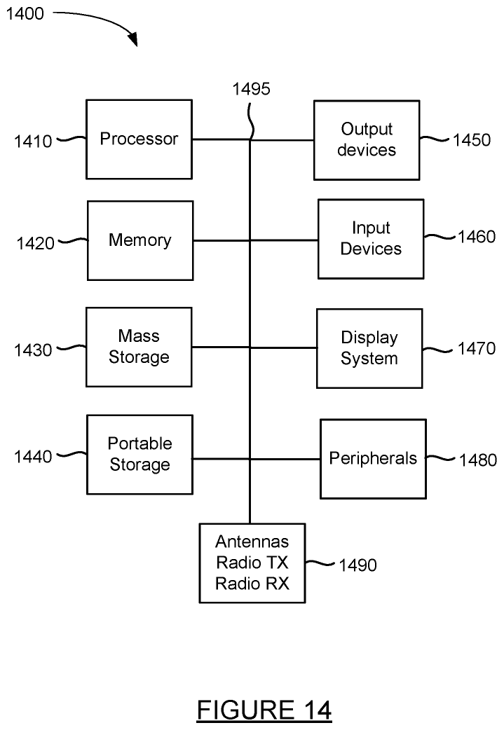

FIG. 14 is a block diagram of a computing environment for implementing the present technology. System 1400 of FIG. 14 may be implemented in the contexts of the likes of machines that implement machine learning model 110, application server 120, chat application server 130, and client device 140. The computing system 1400 of FIG. 14 includes one or more processors 1410 and memory 1420. Main memory 1420 stores, in part, instructions and data for execution by processor 1410. Main memory 1420 can store the executable code when in operation. The system 1400 of FIG. 14 further includes a mass storage device 1430, portable storage medium drive(s) 1440, output devices 1450, user input devices 1460, a graphics display 1470, and peripheral devices 1480.

The components shown in FIG. 14 are depicted as being connected via a single bus 1495. However, the components may be connected through one or more data transport means. For example, processor unit 1410 and main memory 1420 may be connected via a local microprocessor bus, and the mass storage device 1430, peripheral device(s) 1480, portable storage device 1440, and display system 1470 may be connected via one or more input/output (I/O) buses.

Mass storage device 1430, which may be implemented with a magnetic disk drive, an optical disk drive, a flash drive, or other device, is a non-volatile storage device for storing data and instructions for use by processor unit 1410. Mass storage device 1430 can store the system software for implementing embodiments of the present invention for purposes of loading that software into main memory 1420.

Portable storage device 1440 operates in conjunction with a portable non-volatile storage medium, such as a floppy disk, compact disk or Digital video disc, USB drive, memory card or stick, or other portable or removable memory, to input and output data and code to and from the computer system 1400 of FIG. 14. The system software for implementing embodiments of the present invention may be stored on such a portable medium and input to the computer system 1400 via the portable storage device 1440.

Input devices 1460 provide a portion of a user interface. Input devices 1460 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1400 as shown in FIG. 14 includes output devices 1450. Examples of suitable output devices include speakers, printers, network interfaces, and monitors.

Display system 1470 may include a liquid crystal display (LCD) or other suitable display device. Display system 1470 receives textual and graphical information and processes the information for output to the display device. Display system 1470 may also receive input as a touch-screen.

Peripherals 1480 may include any type of computer support device to add additional functionality to the computer system. For example, peripheral device(s) 1480 may include a modem or a router, printer, and other device.

The system of 1400 may also include, in some implementations, antennas, radio transmitters and radio receivers 1490. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1400 of FIG. 14 are those typically found in computer systems that may be suitable for use with embodiments of the present invention and are intended to represent a broad category of such computer components that are well known in the art. Thus, the computer system 1400 of FIG. 14 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for providing a state-machine driven automated agent, comprising:
receiving user inquiry data by a server from a remote device associated with a user;
predicting a response at a first state in a set of nested state machines, the response generated based on the user inquiry data;
automatically performing an audit of the predicted response at a second state in the set of nested state machines; and
transmitting the audited predicted response to the remote device if the automatically performed audit does not incur an error.

2. The method of claim 1, wherein the user inquiry is part of a communication session between an automated agent provided at least in part by the server and a user interactive client application on the remote device.

3. The method of claim 1, wherein a decision to transition from at least one state to another state in the set of nested state machines is based on an output of a machine learning model.

4. The method of claim 3, wherein the machine learning model includes a large language model, wherein a current state outputs a prompt that is provided to the large language model to determine which state the state machine should transition to next.

5. The method of claim 4, wherein at least a portion of the prompt is received by a current state from a previous state.

6. The method of claim 1, wherein the set of nested state machines includes:
a second state for predicting a function; and
a first nested state machine nested in the second state, the first nested state machine including one or more states to predict a program for execution and execute the predicted program.

7. The method of claim 1, wherein the set of nested state machines includes:
a third state for automatically auditing a predicted response; and
a second nested state machine nested in the third state, the second nested state machine including one or more states to audit each of one or more instructions determined to be relevant to processing the user inquiry data.

8. The method of claim 1, wherein further comprising:
detecting, by the audit, an error in the predicted response; and
transitioning to a fourth state that resolves errors detected by the audit.

9. The method of claim 8, wherein the fourth state includes a nested state machine within the fourth state that encapsulates state machine activity data related to generating the predicted response and generates instructions related to an error detected by the audit of the predicted response.

10. A non-transitory computer readable storage medium having embodied thereon a program, the program being executable by a processor to providing a state-machine driven automated agent, the method comprising:
receiving user inquiry data by a server from a remote device associated with a user;
predicting a response at a first state in a set of nested state machines, the response generated based on the user inquiry data;
automatically performing an audit of the predicted response at a second state in the set of nested state machines; and
transmitting the audited predicted response to the remote device if the automatically performed audit does not incur an error.

11. The non-transitory computer readable storage medium of claim 10, wherein the user inquiry is part of a communication session between an automated agent provided at least in part by the server and a user interactive client application on the remote device.

12. The non-transitory computer readable storage medium of claim 10, wherein a decision to transition from at least one state to another state in the set of nested state machines is based on an output of a machine learning model.

13. The non-transitory computer readable storage medium of claim 12, wherein the machine learning model includes a large language model, wherein a current state outputs a prompt that is provided to the large language model to determine which state the state machine should transition to next.

14. The non-transitory computer readable storage medium of claim 13, wherein at least a portion of the prompt is received by a current state from a previous state.

15. The non-transitory computer readable storage medium of claim 10, wherein the set of nested state machines includes:
a second state for predicting a function; and
a first nested state machine nested in the second state, the first nested state machine including one or more states to predict a program for execution and execute the predicted program.

16. The non-transitory computer readable storage medium of claim 10, wherein the set of nested state machines includes:
a third state for automatically auditing a predicted response; and
a second nested state machine nested in the third state, the second nested state machine including one or more states to audit each of one or more instructions determined to be relevant to processing the user inquiry data.

17. The non-transitory computer readable storage medium of claim 10, wherein further comprising:
detecting, by the audit, an error in the predicted response; and
transitioning to a fourth state that resolves errors detected by the audit.

18. The non-transitory computer readable storage medium of claim 17, wherein the fourth state includes a nested state machine within the fourth state that encapsulates state machine activity data related to generating the predicted response and generates instructions related to an error detected by the audit of the predicted response.

19. A system for providing an automated agent, comprising:
one or more servers, wherein each server includes a memory and a processor; and
one or more modules stored in the memory and executed by at least one of the one or more processors to receive user inquiry data by a server from a remote device associated with a user, predict a response at a first state in a set of nested state machines, the response generated based on the user inquiry data, automatically perform an audit of the predicted response at a second state in the set of nested state machines, and automatically transmit the audited predicted response to the remote device if the automatically performed audit does not incur an error.

20. The system of claim 15, wherein a decision to transition from at least one state to another state in the set of nested state machines is based on an output of a machine learning model.
